(19) United States
(12) Patent Application Publication
(10) Pub. No.: US 2025/0045708 A1
(43) Pub. Date: Feb. 6, 2025

(54) METHOD OF TRACKING SERVICE

(71) Applicant: LEXMARK INTERNATIONAL, INC., LEXINGTON, KY (US)

(72) Inventors: TOMASZ JAN CHOLEWO, LEXINGTON, KY (US); CHAD EUGENE MCQUILLEN, LEXINGTON, KY (US); ROBERT HENRY MUYSKENS, LEXINGTON, KY (US); KENNETH C NAPIER, GEORGETOWN, KY (US); RICHARD L REEL, SADIEVILLE, KY (US)

(21) Appl. No.: 18/791,984

(22) Filed: Aug. 1, 2024

Related U.S. Application Data
(60) Provisional application No. 63/530,120, filed on Aug. 1, 2023.

(51) Int. Cl. G06Q 10/20; G06V 20/50

(52) U.S. Cl. CPC G06Q 10/20; G06V 20/50

(57) ABSTRACT

A service tracking method is disclosed that will assist the vehicle quick service market, such as oil change services. The purpose is to track key performance indicators (KPIs) that will correlate to customer satisfaction. The metrics collected include at least: (1) time spent waiting to be greeted and serviced, (2) actual service time, and (3) lost revenue opportunities associated with impatient customers driving off. It achieves this utilizing computer vision to (1) detect cars, (2) service personnel, and (3) in-use service bays and then reporting the KPIs on an in-store real-time display

### CROSS REFERENCES TO RELATED APPLICATIONS

This application claims priority to U.S. Provisional Patent Application No. 63/530,120, filed Aug. 1, 2023.

### BACKGROUND

### 1. Field of the Invention

This invention relates generally to vehicle tracking in service facilities.

### 2. Description of the Related Art

Methods of tracking customer interactions and satisfaction exist in some form across the retail industries.

### SUMMARY OF THE INVENTION

A service tracking method is disclosed that will assist the vehicle quick service market, such as oil change services. The purpose is to track key performance indicators (KPIs) that will correlate to customer satisfaction. The metrics collected include at least: (1) time spent waiting to be greeted and serviced, (2) actual service time, and (3) lost revenue opportunities associated with impatient customers driving off. It achieves this utilizing computer vision to (1) detect cars, (2) service personnel, and (3) in-use service bays and then reporting the KPIs on an in-store real-time display as shown in FIG. 1.

### BRIEF DESCRIPTION OF THE DRAWINGS

Having thus described the invention in general terms, reference will now be made to the accompanying drawings, which are not necessarily drawn to scale, and wherein:

FIG. 1 shows an in-store real-time display tracking key performance indicators.

FIG. 2 shows vehicle lanes entering a facility that are visible to the operator on a screen showing an exterior facility view.

FIG. 3A shows a wait queue where vehicle tracking identification numbers are stored.

FIG. 3B shows the steps for associating a missing wait queue vehicle to one of three data queues (bay entry candidate, drive-off or discard).

FIG. 4A shows the service bay status.

FIG. 4B shows the steps for associating a queued vehicle to a service bay.

FIG. 5 shows the method for addressing stacked bay logic.

FIG. 6 shows a method for handling service bay configurations that are stacked where a vehicle in the rear bay (closest to service bay entrance) will complete service before the vehicle in the front bay (closest to service bay exit).

FIG. 7 shows two different strategies that can be utilized to optimize the choice for which service bay a newly arrived vehicle should be directed.

FIG. 8 shows a method for tracking vehicle service times.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art.

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

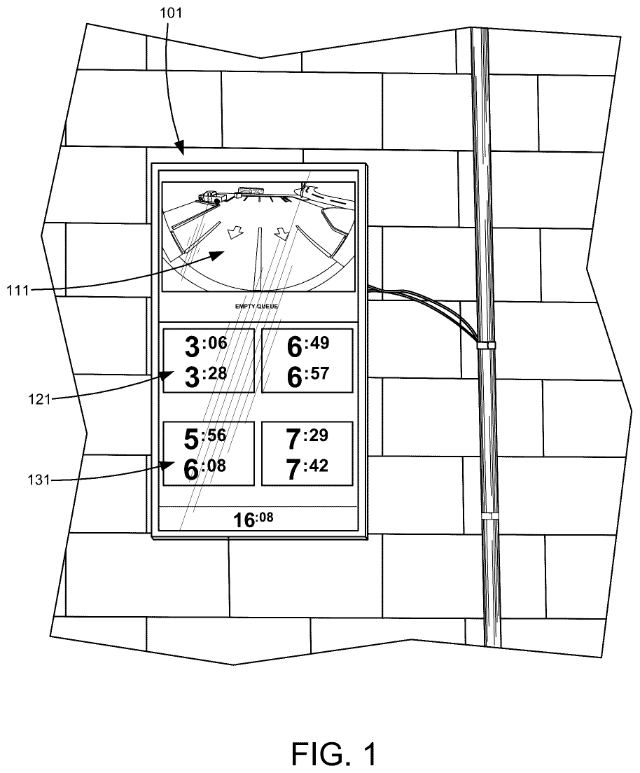

Referring initially to FIG. 1, which shows an in-store real-time display 101 tracking key performance indicators 121, 131. In this example of, vehicle lanes entering the facility are visible to the operator on a screen showing an exterior view 111.

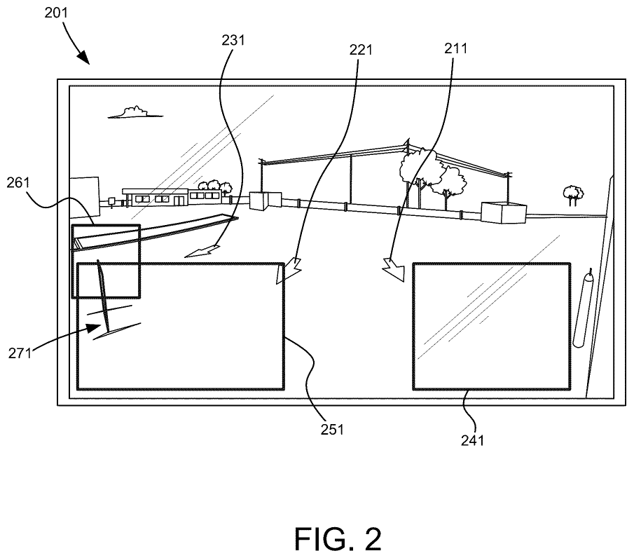

FIG. 2 shows vehicle lanes entering a facility that are visible to the operator on a screen showing an exterior facility view 201. Three vehicle lanes 211, 221, and 231 are shown. A bay entry region is defined or learned over time, which is polygon 241, 251,261 that defines the entry point to each service bay. These regions will be used to assign cars to service bays when multiple cars enter different bays at the same time. An object tracker uses visual heuristics (such as height, width, volume, etc.) to assign tracking identifiers to detected objects for tracking them through time and location in a scene even accounting for when they may be temporarily occluded by other objects, such as the sign 271 shown in FIG. 2. Occlusions occur when a trained model of a target object fails to detect the target object due to completely or partially obscured views.

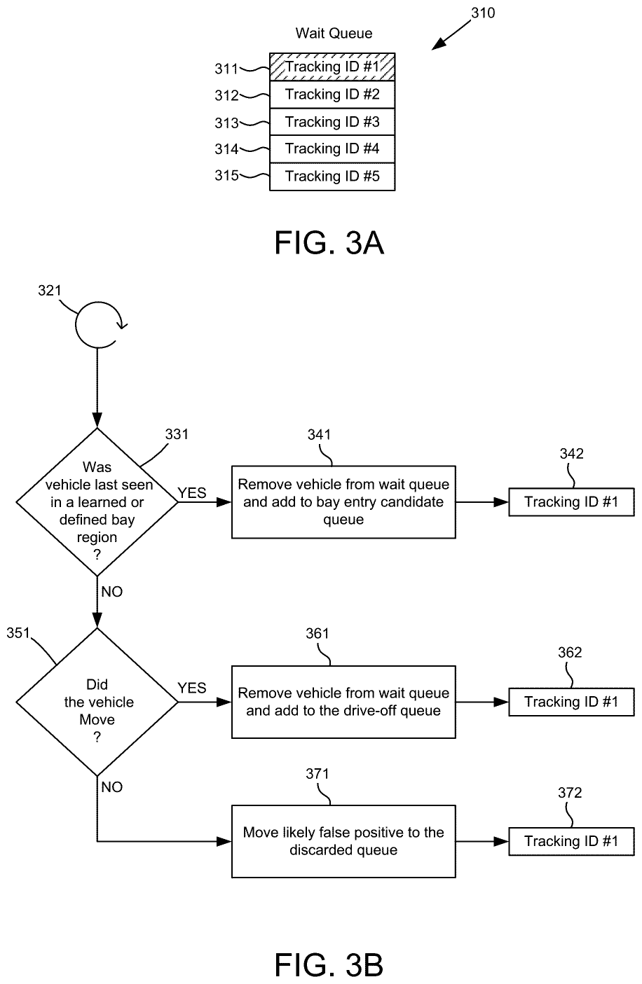

FIG. 3A shows a wait queue 301 where vehicle tracking identification numbers 311, 312, 313, 314, 315 are stored.

FIG. 3B shows the steps for associating a missing wait queue vehicle to one of three data queues (bay entry candidate, drive-off or discard). To track the total time at the facility for a given vehicle, an accurate association must be made of a vehicle transitioning from the outdoor camera monitoring the service queue to one of the cameras monitoring the in-store service bays. The method must account for false positives (detecting a car that really isn't there) and false negatives (not detecting a car). The method employs “smoothing logic” to filter out these false states to stay latched on to the true state of the scene. The algorithm also self-learns the bay entry regions of interest that can be used to disambiguate vehicles that simultaneously enter the service bays from the outdoor waiting queue.

The algorithm for self-learning is setup by asking for a “bay entry region” to be drawn by the installer. This is a single polygon that covers all the lanes and doors with enough lane depth to include one waiting car in each lane. The best mode is to have a query sampling every 10 seconds for cars that have stopped getting updates for oil change application. The query rate will be varied by the standard anticipated turn time of a service. Automobiles will typically be services every 15 minutes, so the ratio is approximately 60 to 1. A tractor trailer oil service time will take approximately 1 hour which means that the best mode for this application would be 40 seconds. To improve software performance the query time should be up to 50% less often. To speed the learning process the query time should be up to 50% more often. Depending on where the car was last seen that car will go into 3 queues that are the bay entry, drive-off, or discarded. If the car never moved it goes into the discard pile for an assumed false positive. If the car is in this “bay entry region” it goes into the bay entry queue. Also, if the car is in a “learned” region it goes into the bay entry queue. If the car is outside these regions it goes into the “drive-off queue.” When a car appears inside in the service bays it starts in an unassigned state. Every queue sampling time, an unassigned car will be associated these to the “bay entry cars.” When there is only one car in the bay entry queue and not associated in the service bays then this is the “learning” moment. This assignment is when the only choice from outside to the only choice inside. The last bounding box location outside is saved in small list of regions associated with this bay (or lane). The overlapping region of the last two “learned” cars creates the “learned” region for Lane 1 (Bay 1). The learned region is important when more than one car exists in the bay entry queue or not associated in the service bays. The learned regions are used to filter out which cars to use for which service bay lane.

The “learned region” is self-adjusting over a short period of time in the case of camera changes. If the installer forgets to draw the initial bay entry region, then every car that is entering the bays is used to learned regions for all the lanes. After this point it will operate fine without that initial drawn region. This system works well because more than 90% of the cars in a day go in one at a time so there is lots of learning chances.

The first step 321 is to periodically look for tracking identifiers that are no longer present in the wait queue. The second step 331 is to query whether the vehicle was last seen in a learned or defined bay region. If yes, the vehicle is removed from the wait queue and added to the bay entry candidate queue 341, and then assigned a tracking identifier 342. If not, then the third step 351 is to query whether the vehicle moved. If so, then the vehicle is removed from the wait queue and added to the drive-off queue 361, and then assigned a tracking identifier 362. If the vehicle did not move, the likely false positive is moved to the discard queue 371 and assigned an identifier 372.

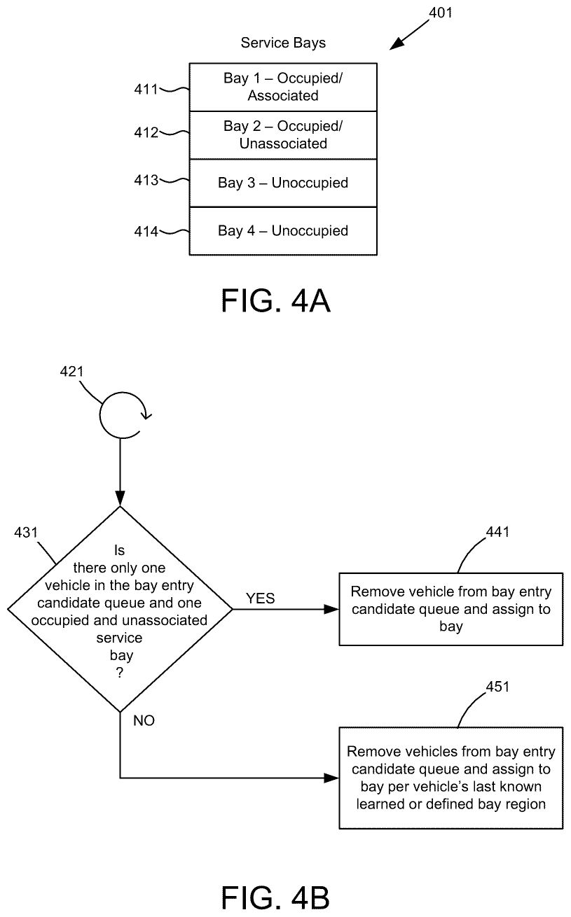

FIG. 4A shows the service bay status 401 where the service bays are designated as occupied/associated as is shown for Bay 1, 411, and Bay 2, 412, or as unoccupied as is shown for Bays 3 and 4, 413, 414.

FIG. 4B shows the steps for associating a queued vehicle to a service bay. The first step 421 is to periodically evaluate the service bay queue for unassociated vehicles. Here again, the method employs “smoothing logic” to filter out these false states. If an unassociated vehicle is identified, then the next step 431 is to determine if there is only one vehicle in the bay entry candidate queue and one occupied and one unassociated service bay. If so, then the vehicle is removed from the bay entry candidate queue and assigned to a bay 441. The learned bay entry region for this bay is updated. If multiple vehicles exist in the bay entry candidate queue or multiple unassociated service bays exist the vehicle is removed from the bay entry candidate queue and assigned to a bay per the vehicle's last known learned or defined bay region 451.

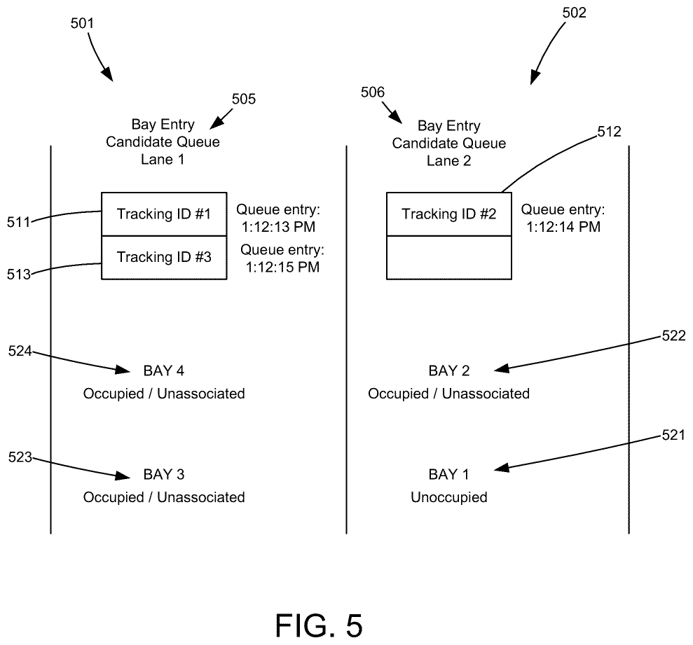

FIG. 5 shows the method for addressing stacked bay logic. Two lanes 501, 502 for entry into the service bays 521, 522, 523, 524 are shown. Two vehicles with tracker identifiers 511, 512 enter the service bay nearly simultaneously from Lane 1, 501. The earliest timestamp indicates that vehicle tracker identifier #1, 511, entered the service bay first, and traveled the farthest to Bay 3, 523. The later timestamp for vehicle tracker identifier #3, 513, that entered last travels to Bay 4, 524. Only one vehicle, tracker identifier #2, 512, entered the service bay from Lane 2, 502, and is associated with Bay 1, 521.

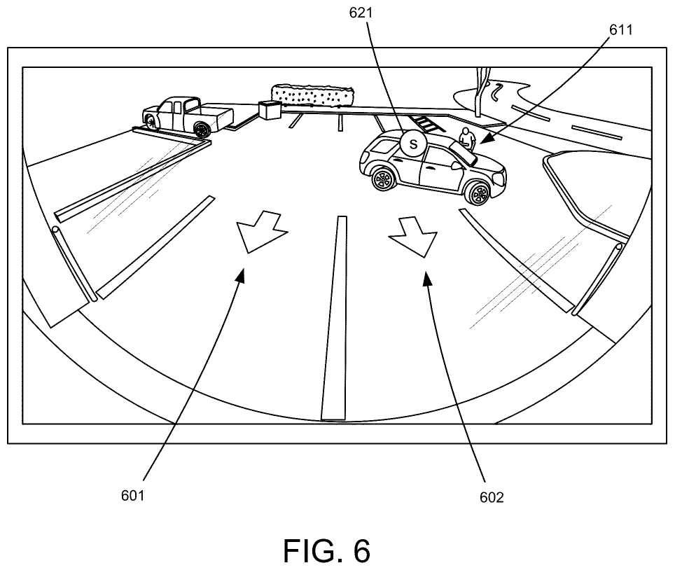

FIG. 6 shows a method for handling service bay configurations that are stacked where a vehicle in the rear bay (closest to service bay entrance) will complete service before the vehicle in the front bay (closest to service bay exit). An employee 611 will direct the vehicle 621 operator to back out of the service bay and exit the facility from the lane 602 in which they entered. Such an event is not treated as a drive-off, a vehicle that backs up and exits the facility, often due to an undesired wait duration.

Additional steps can be added such as detection of engagement between a service employee and a customer such as for greetings. Greetings occur when a service employee engages a customer in a vehicle who is waiting in line for a service bay to become available. The method can use one or more of the following techniques to detect the service employee: (1) a trained model that can detect people with a secondary classifier that is trained to recognize the uniform and/or personal protection equipment (safety glasses) of the service employee; or (2) when a model identifies a person, the location in which the person first appeared can be used to infer a service employee. If the person's travelled path begins and ends near a learned or defined bay entry region of interest, then that can be used to infer with high confidence a service employee.

Detection of engagement between the service employee and a customer may utilize one or more of the following factors. First, the orientation of the bounding box of a detected vehicle may be used to determine driver side location. Portrait orientation may indicate that the vehicle is pointed towards the service bay entrance and the driver side door would be on the right side of the bounding box. Landscape orientation may indicate the vehicle is broad-side to the service bay (as is the case when the path to the service bays starts from the front of the store and vehicles are required to navigate to the back turning into line for entry into the service bays) and the driver side door would be roughly located in the mid-section of the vehicle's bounding box. Second, the proximity of service employee to a customer's vehicle. Third, a body position and pose estimator may be used to determine the orientation of the service employee in relation to the customer vehicle. Fourth, a minimum time threshold may be used to define what constitutes engagement.

The application may also take into account vehicles that immediately enter the service bay from the service queue by not counting those as failed greetings. A threshold of time is required for the vehicle to be waiting in the service queue before tracking a successful or failed greeting.

Reportable metrics on drive-offs are important because they are an indication of lost revenue and decreased customer satisfaction. The application must guard against an over-reporting of this metric due to false detections and impaired tracker performance from occlusions. By incorporating an object tracker into the application, we can track the traveled paths of vehicles. False detections of vehicles typically involve detections which are transient in nature and generally do not change location. Per the algorithm described in “Queued Vehicle to Bay Association” we can simply ignore these vehicles. We can utilize information about the travel path of tracked vehicles to disambiguate vehicles which have exited the site versus those vehicles which were assigned new tracking IDs as they re-emerged from an occlusion. We can compare the last known location of a vehicle to the learned or manually drawn entry/exit region to know whether a legitimate drive-off has occurred.

By self-learning regions of interest, the need for an installation technician to manually draw regions of interest—potentially sub-optimally—may be avoided. Installation technicians, however, are better equipped to answer setup questions such as: “ow many site entrances are there?” By doing so, clustering algorithms (for example, a k-means clustering algorithm) may be leveraged on the final known location of exiting vehicles to determine exit locations.

Accumulating travel paths of vehicles over time allows a heat-map to be built of where vehicles travel through the site. Such a heat map may identify the service queue region of interest and allow the application to filter out parked cars that reside on the lot and are visible to the outdoor camera. Further, an object tracker, allows an estimate of the velocity of vehicles to filter out the faster moving vehicles on nearby roads.

Sometimes the parking areas are used to stage customers. The method must utilize context to differentiate between parked employee vehicles and temporarily staged customer vehicles. Time of day and service bay availability can be utilized to filter out employee parked vehicles from being tracked as a customer vehicle in the application. For example, early in the morning when employees arrive, and service bays are unoccupied a vehicle that appears in the parking region of interest (either manually defined or learned) can use a lower time threshold of no detected motion to determine that it is an employee vehicle. Conversely, during normal working hours and while service bays are occupied a vehicle that appears in the parking region of interest would require a much longer time threshold before determining that it is an employee vehicle since it is more likely to be a customer vehicle. Additional factors may include number of vehicles in the service queue region of interest.

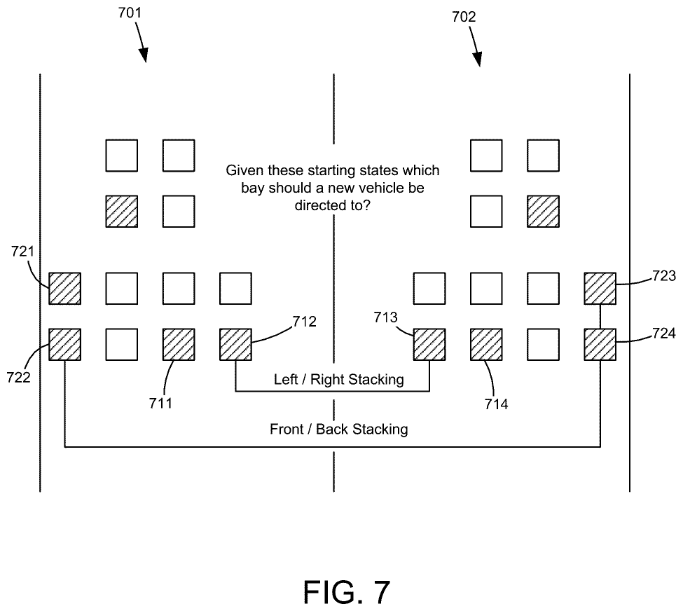

A service facility may decide that there is an optimal choice for which service bay a newly arrived vehicle should be directed. FIG. 7 shows examples of two different strategies that can be utilized given these similar starting states. Given the starting states of either Left/Right stacking, 711, 712, 713, 714 or Front/Back stacking 721, 722, 723, 724, the optimal choice of bay 701, 702 may be determined.

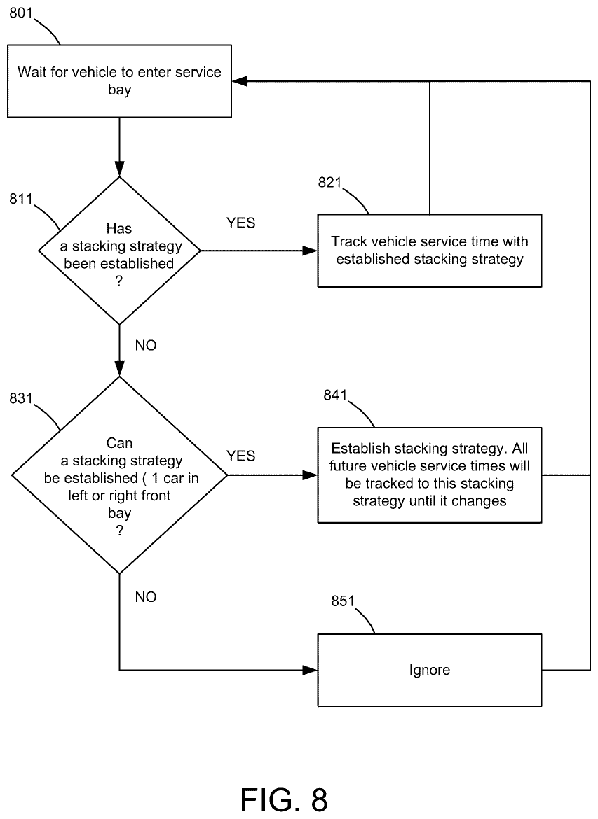

FIG. 8 shows a method for tracking vehicle service times. The first step 801 is waiting for a vehicle to enter the service bay. The second step is to query whether a stacking strategy has been established 811. If yes, the vehicle service time is tracked with the established stacking strategy 821. If not, then a determination is made whether a stacking strategy can be established 831. If yes, then the stacking strategy is established and all future vehicle service times will be tracked to this stacking strategy until the strategy is changed. The service operator can correlate average service times across different time intervals against a given service bay strategy to determine the optimum strategy.

It is common for fixed infrastructure such as cameras to utilize static internet address assignments (i.e., they never change as they do with DHCP). A standard internet address assignment scheme could be developed such that the application could auto-discover the bay configuration and cameras assigned to monitor each bay. As an example, 0.101, 0.102, 0.103 could be utilized to denote a simple three bay service bay configuration whereas 0.111, 0.112, 0.121, 0.122 could be utilized to denote a stacked 2×2 bay (where 0.11× could be front row, 0.12× could be back row).

An in-store display visualizes the order of entry of vehicles to the service queue and the greeting status of each vehicle via numeric and color-coded badges which overlay the vehicle. This helps employees who are actively engaged with customers and vehicles already in the service bay to know which vehicles arrived first and consequently the proper order to greet customers.

The interaction of a staff/technician with customers when they are parked outside in a waiting queue helps prevent customers from driving-off. When a customer arrives, they should be greeted and so they are visualized on the in-store screen with a red dot, until they are greeted and become green. The solution will continually compute a predicted risk of drive-off metric, and based on the drive-off risk score for every waiting vehicle the in-store display will adjust visualizations and make suggested actions (re-greeting, offering a coupon, re-communicating estimated wait time, etc.)

Examples of factors that can be monitored by a camera algorithm and used to recommend a re-greeting (a technician revisiting the customer's window again) include: (1) time since last technician greeting; (2) number of cars in the queue “in-front” of the customer; (3) number of vehicles appearing to be serviced in the parking lot; (4) number of vehicles behind the customer's vehicle; (5) time of day; and (6) day of the week

The more “chaos” of cars moving and waiting in the lot equates to a higher risk of any given customer exiting. When a customer is in a chaotic waiting queue, an additional key element of the logic they consider while deciding whether to drive-off is whether there is a car behind them which is blocking their exit. During the reshuffling of cars in the waiting queue, if the customer has been waiting and becomes “unblocked from exiting the lot,” there will be an increased likelihood of their deciding to exit. In this case there will be an increased drive-off risk score. If the risk score increases above a threshold (fixed or dynamic by time of day, or other factor) then the in-store display (or mobile notification) will trigger a recommended remediation action(s) by the staff.

Examples of visualization methods that could be used to represent a need for re-greeting include: (1) changing the color of the vehicle's dot on the image; (2) blinking the dot on-screen; (3) visual pop-up alert notice; or (4) an audible beep

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

We claim:

1. A service tracking method, comprising:
defining vehicle lanes entering a facility that are visible to an operator on a screen showing an exterior facility view;
defining a region of interest that directs an object tracker what to pay attention to or ignore; and
using an object tracker with visual heuristics to assign at least one tracking identifier to detect an object and tracking the object through time.

2. The method of claim 1 where the facility is an oil change operation.

3. The method of claim 1 where the heuristics include at least height and width.

4. A method for associating a missing wait queue vehicle to one of three data queues (bay entry candidate, drive-off or discard) at a facility, comprising:
periodically looking for tracking identifiers that are no longer present in a wait queue;
querying whether a vehicle was last seen in a learned or defined bay region;
removing the vehicle from the wait queue if in a defined region and adding the vehicle to the bay entry candidate queue
assigning a tracking identifier to the vehicle;
querying whether the vehicle has moved if it is not in a defined bay region, and if so, removing the vehicle from the wait queue and added to the drive-off queue and assigning a tracking identifier.

5. The method of claim 4 where the facility is an oil change operation.

6. The method of claim 4 where periodically is defined as less than 15 seconds.

7. A method for associating a queued vehicle to a service bay at a facility, comprising:
periodically evaluating the service bay queue for unassociated vehicles;
if an unassociated vehicle is identified, determining if there is only one vehicle in the bay entry candidate queue and one occupied and one unassociated service bay, and if so, removing the vehicle from the bay entry candidate queue and assigning it to a bay;
updating the learned bay entry region for the assigned bay;
if there is not only one vehicle in the bay entry candidate queue and not one occupied and one unassociated service bay, then removing the vehicle from the bay entry candidate queue and assigning to a bay; and
if multiple vehicles exist in the bay entry candidate queue or multiple unassociated service bays exist the vehicle is removed from the bay entry candidate queue and assigned to a bay per the vehicle's last known learned or defined bay region.

8. The method of claim 7 where the facility is an oil change operation.

9. The method of claim 7 where periodically is defined as less than 15 seconds.
